(19) United States
(12) Patent Application Publication
(10) Pub. No.: US 2006/0161945 A1
(43) Pub. Date: Jul. 20, 2006

(54) Method for informing video receiving delay and broadcast receiving apparatus thereof

(75) Inventor: Jae-hoon Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/322,391

(22) Filed: Jan. 3, 2006

(30) Foreign Application Priority Data
Jan. 14, 2005 (KR) 2005-3728

(51) Int. Cl. H04N 7/10; H04N 5/50

(52) U.S. Cl. 725/32; 348/569

(57) ABSTRACT

Disclosed are a method for informing a user of video receiving delay and a broadcast receiving apparatus thereof. The method includes separating a video signal from a received broadcast signal, and decoding and storing the video signal; determining if a video signal corresponding to the first frame of video is completely decoded, after a certain amount of time from the beginning of receiving the broadcast signal; and processing to display information on video receiving delay, if it is determined that the video signal corresponding to the first frame of the video is not completely decoded. When audio is normally output but corresponding video is not output yet at the beginning of receiving music broadcast, a user will be informed of the video receiving delay. Accordingly, the user can recognize that video will be output soon and will not think that the broadcast receiving apparatus is malfunctioning.

### CROSS-REFERENCE TO RELATED APPLICATIONS

This application claims benefit under 35 U.S.C. §119(a) of Korean Patent Application No. 2005-3728, filed Jan. 14, 2005, the entire contents of which are incorporated herein by reference.

### BACKGROUND OF THE INVENTION

1. Field of the Invention

The present invention relates to a method for informing video receiving delay and a broadcast receiving apparatus thereof. More particularly, the present invention relates to a method for informing a user of video receiving delay when receiving video is delayed, and a broadcast receiving apparatus thereof.

2. Description of the Related Art

A broadcast receiving apparatus operates to receive a selected broadcast signal, and process the signal to output the received broadcast signal via a display and a speaker. There are, for example, broadcast receiving apparatus such as a television, set top box and television with a built-in set top box. Further, recently, it is possible to receive broadcasts through mobile terminal devices, so that the mobile terminal device belongs to the broadcast receiving apparatus category.

Broadcast includes music broadcast. Recently, music broadcast service provides video as well as audio. This is because visual entertainment as well as auditory entertainment for users is considered. In general, however, still images or slide images, rather than moving images for video, are provided.

Meanwhile, the main purpose of music broadcast service is to provide audio, so that most of the bandwidth of the broadcast signal is allocated to transmit an audio signal, and a little bit of the bandwidth of the broadcast signal is allocated to transmit a video signal.

Therefore, a transmission rate of the audio signal is high, but a transmission rate of the video signal is relatively low. So, it takes a certain amount of time for the broadcast receiving apparatus to completely receive and output the video signal for the first frame of video. As a result, when the music broadcast is initially received, video may not be output while corresponding audio is already output.

If video is output a certain amount of time later than the corresponding audio, a user may feel impatient with the video delay. Furthermore, when the user does not recognize this situation, he or she may misunderstand this as an operation error.

### SUMMARY OF THE INVENTION

An aspect of the present invention is to solve at least the above problems and/or disadvantages described above, to solve other disadvantages that may not be described above, and to provide at least the advantages described below. Accordingly, an aspect of the present invention is to provide a method for informing a user of a video receiving delay and a broadcast receiving apparatus thereof, and to prevent a user from misunderstanding the video delay as an operation error, by displaying information for informing video receiving delay on the user's screen, when audio is normally being output but video is not being output yet at the beginning of receiving music broadcast. Also, the present invention is not required to overcome the disadvantages described above, and an illustrative, non-limiting embodiment of the present invention may not overcome any of the problems described above.

In order to achieve the above-described aspects of the present invention, there is provided a method for informing video receiving delay, comprising separating a video signal from a received broadcast signal, decoding, and storing the video signal, determining if a video signal corresponding to the first frame of video is completely decoded, after a certain amount of time from the beginning of receiving the broadcast signal, and processing to display information on video receiving delay, if it is determined that the video signal corresponding to the first frame of the video is not completely decoded.

The method may further comprise determining a rate of receiving the video signal, and processing to display the determined receiving rate.

The rate of receiving the video signal may be determined by referring to a header of the video signal.

In addition, the method may further comprise determining the rate of receiving the video signal, calculating an estimated point of time to completely decode the video signal corresponding to the first frame of the video based on the determined receiving rate, and processing to display the calculated, estimated point of time.

The broadcast signal may be a music broadcast signal transmitted from a music broadcasting station.

A receiving rate of an audio signal of the music broadcast signal is equal to or greater than a receiving rate of the audio signal of a general broadcast signal, and a receiving rate of the video signal of the music broadcast signal is less than a receiving rate of the video signal of the general broadcast signal.

A bandwidth allocated to the audio signal out of the entire bandwidth of the music broadcast signal is equal to or greater than a bandwidth allocated to the audio signal of the general broadcast signal, and a bandwidth allocated to the video signal out of the entire bandwidth of the music broadcast signal is less than a bandwidth allocated to the video signal included in the general broadcast signal.

According to another aspect of the present invention, there is provided a broadcast receiving apparatus comprising a display information combining part for processing to display a predetermined information on display, a determination part for determining if the video signal corresponding to the first frame of the video is completely decoded, after a certain amount of time from the beginning of receiving the broadcast signal, and a controlling part for controlling the display information combining part to display information on video receiving delay, if the determination part determines that the video signal corresponding to the first frame of the video is not completely decoded.

The determination part can determine the rate of receiving the video signal, and the controlling part can control the display information combining part to display the receiving rate determined by the determination part.

The determination part may determine the receiving rate of the video signal, referring to the header of the video signal.

The determination part may determine the receiving rate of the video signal, and the controlling part may calculate an estimated point of time to completely decode video signal corresponding to the first frame of the video based on the determined receiving rate, and control the display information combining part to display the calculated estimated point of time.

The broadcast signal may be the music broadcast signal transmitted from the music broadcasting station.

The receiving rate of the audio signal of the music broadcast signal may be equal to or greater than the receiving rate of the audio signal of the general broadcast signal, and the receiving rate of the video signal of the music broadcast signal may be less than the receiving rate of the video signal of the general broadcast signal.

The bandwidth allocated to the audio signal out of the entire bandwidth of the music broadcast signal may be equal to or greater than the bandwidth allocated to the audio signal of the general broadcast signal, and the bandwidth allocated to the video signal out of the entire bandwidth of the music broadcast signal may be less than the bandwidth allocated to the video signal of the general broadcast signal.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a block diagram of a digital television (DTV) of a broadcast receiving apparatus for informing video receiving delay according to an embodiment of the present invention.

FIG. 2 is a flowchart showing a method for informing video receiving delay according to the embodiment of the present invention.

### DETAILED DESCRIPTION OF THE EXEMPLARY EMBODIMENTS

Hereinafter, an embodiment of the present invention will be described in detail with reference to the accompanying drawing figures.

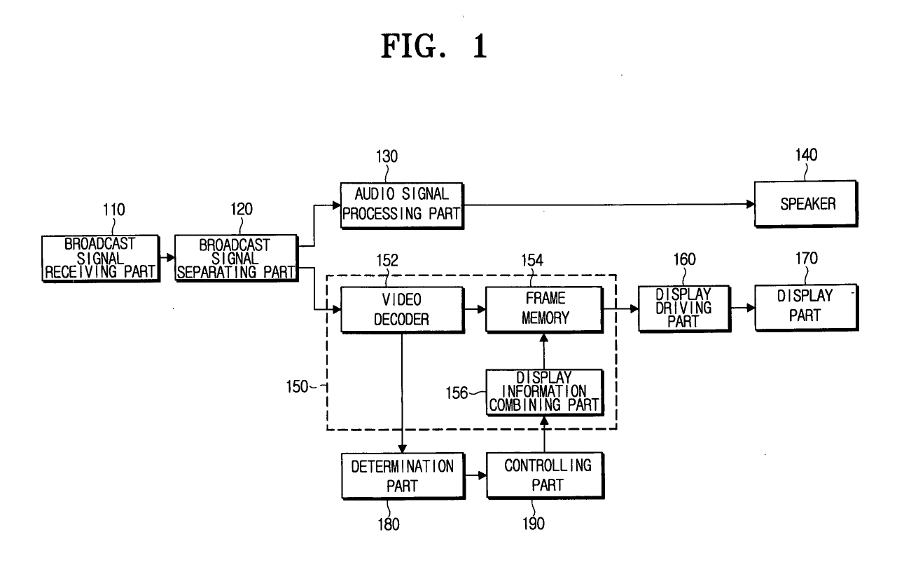

FIG. 1 is a block diagram of a digital television (DTV) of a broadcast receiving apparatus for informing video receiving delay according to an embodiment of the present invention. Referring to FIG. 1, the DTV has a broadcast signal receiving part 110, a broadcast signal separating part 120, an audio signal processing part 130, a speaker 140, a video signal processing part 150, a display driving part 160, a display part 170, a determination part 180, and a controlling part 190.

The broadcast signal receiving part 110 selects one of broadcast signals which it is capable of wiredly or wirelessly receiving through a cable or an antenna. And then the broadcast signal receiving part 110 demodulates and detects the selected broadcast signal. The broadcast signal separating part 120 separates audio signal, video signal and other information signal from the broadcast signal output from the broadcast signal receiving part 110. The separated audio signal is sent to the audio signal processing part 130, the separated video signal to the video signal processing part 150, and the separated other information signal is set to another information signal processing part (not shown).

The audio signal processing part 130 performs a decoding process to expand the applied audio signal. Accordingly, audio corresponding to the expanded audio signal is output to the speaker 140.

The video signal processing part 150 has a video decoder 152, a frame memory 154, and a display information combining part 156.

The video decoder 152 performs a decoding process to expand the applied video signal. The expanded video signal is stored to the frame memory 154.

The display information combining part 156 processes to display the display information on a certain part of the screen of the display part 170. Specifically, the display information combining part 156 may display the display information according to an on-screen-display (OSD) scheme. For this, the display information combining part 156 stores the display information in corresponding addresses of the frame memory 154 according to the control of the controlling part 190.

The display driving part 160 displays video corresponding to the video signal stored in the frame memory 154 through the display part 170.

The determination part 180 determines i) if receiving video is delayed at the beginning of the music broadcast reception, and ii) a video receiving rate. The determined result is sent to the controlling part 190.

The controlling part 190 controls the display information combining part 156 so that information such as ‘information on video receiving delay’ and ‘video receiving rate’ are displayed on the display part 170. Further, the controlling part 190 controls the overall operation of the DTV according to operation command of a user.

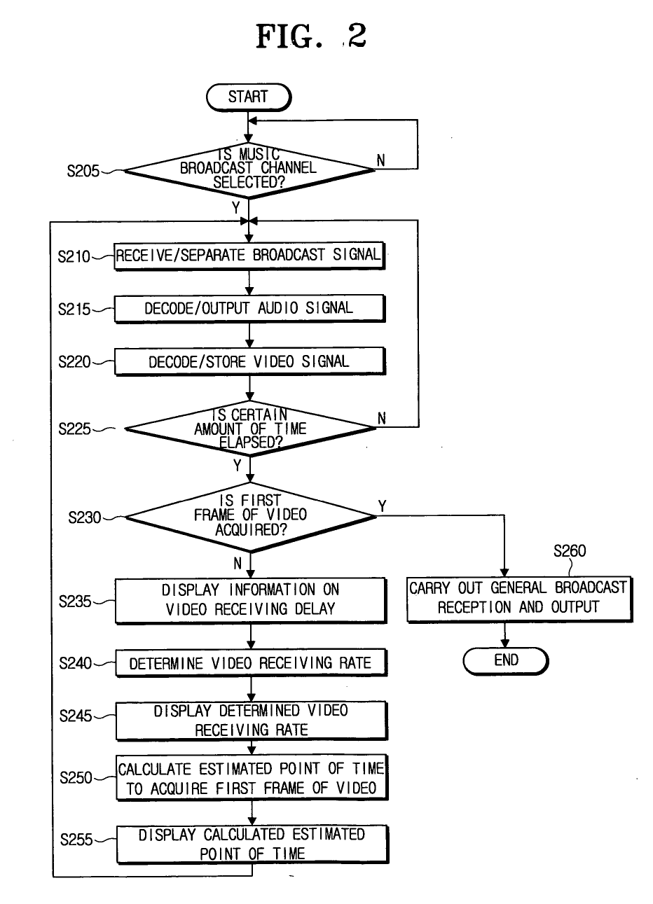

Hereinafter, a procedure that the controlling part 190 informs the user of video receiving delay at the beginning of the music broadcast reception, by using the result of the determination part 180, will be described in detail with reference to FIG. 2. FIG. 2 is a flow chart showing a method for informing video receiving delay according to an embodiment of the present invention.

If a user selects a music broadcast channel (S205), the broadcast signal receiving part 110 receives the broadcast signal transmitted by a music broadcasting station, and the received broadcast signal is separated into an audio signal, a video signal and other information signal in the broadcast signal separating part 120 (S210).

The audio signal processing part 130 decodes to expand the audio signal, and the audio corresponding to the expanded audio signal is output to speaker 140 (S215). Accordingly, the user can listen to the output audio.

During operation of S215, the video decoder 152 performs a decoding process to expand the video signal, and the expanded video signal is stored in the frame memory 154 (S220).

Operations at S210 to S220 continue for a certain amount of time (for example, 2˜3 seconds) from the beginning of the broadcast signal reception (S225). The certain amount of time may be preset by a manufacturer or a user, and can change as necessary.

If the certain amount of time is elapsed from the beginning of broadcast signal reception in S225, the determination part 180 determines if the first frame of video is acquired (S230). The first frame of video refers to the first image of video to be displayed on the display part 170. If the video signal is compressed with moving picture experts group (MPEG) format, the first frame of video is Intra-frame (I-frame).

Specifically, S230 can be implemented by the determination part 180 determining if the video signal corresponding to the first frame of video is completely decoded by the video decoder 152. On the other hand, S230 can also be implemented by the determination part 180 determining if the video signal corresponding to the first frame of video is completely stored in the frame memory 154.

If the first frame of video is determined to be acquired in S230, the controlling part 190 controls the DTV to carry out general broadcast reception and output (S260).

If the first frame of video is determined not to be acquired in S230, the controlling part 190 controls the display information combining part 156 so that ‘information on video receiving delay’ can be displayed on the display part 170 (S235). The user can thus recognize that omission of video output is due to ‘video receiving delay’, and therefore, video will be output soon.

The determination part 180 determines the video receiving rate (S240). Since the video receiving rate is equivalent to a video transmitting rate from a broadcasting station, the determination part 180 may be deemed to determine the video transmitting rate from the broadcasting station.

The information on the video receiving rate is included in the header of the video signal. Therefore, the determination part 180 can determine the video receiving rate by referring to the header of the video signal expanded in the video decoder 152.

In other words, only when the header of the video signal is completely received, the determination part 180 can determine the video receiving rate. If the header of the video signal is determined not to be completely received, the above operation at S240 and the following operation at S245 may then be omitted.

The controlling part 190 controls the display information combining part 156 so that the determined video receiving rate is displayed on the display part 170 (S245). Since the user can check the current video receiving rate, the user can recognize that video is being received at a lower receiving rate.

Meanwhile, the controlling part 190 calculates an estimated point of time to acquire the first frame of video based on the receiving rate determined in S240 (S250). The ‘estimated point of time to acquire the first frame of video’ corresponds to the time when the video signal corresponding to the first frame of video is completely decoded, or an estimated point of time to completely store the video signal.

More specifically, the controlling part 190 can calculate the estimated point of time to acquire the first frame of video, by dividing a ‘general (or statistic) capacity of the first frame of video’ by a ‘determined receiving rate’.

The controlling part 190 then controls the display information combining part 156 so that the calculated estimated point of time is displayed in the display part 170 (S255). Therefore, the user can know when to expect the video output.

Since then, the aforementioned operations at S210 to S255 are repeated until the first frame of video is determined to be acquired in S230.

Until now, when receiving video is delayed at the beginning of receiving the music broadcast, the method for informing a user of this has been described in detail.

According to an embodiment of the present invention, all of i) the video receiving delay; ii) the video receiving rate; and iii) the estimated point of time to acquire the first frame, may not necessarily be altogether provided to a user. They may be selectively implemented.

Further, according to the above embodiments of the present invention, it has been described that the determination part 180 determines if receiving video is delayed and the video receiving rate, and the controlling part 190 controls the display information combining part 156 to display the determined result. However, the function of the determination part 180 may be incorporated into the controlling part 190, and the determination part 180 can be omitted.

When the present invention is applied to receiving the music broadcast transmitted from the music broadcasting station, it can be particularly effective. In the case of the music broadcast, generally a receiving rate of the audio signal of the music broadcast signal is equal to or greater than that of a general broadcast signal, and a receiving rate of the video signal of the music broadcast signal is less than that of the general broadcast signal.

In other words, in the case of the music broadcast, generally bandwidth allocated to the audio signal out of the entire bandwidth of the music broadcast signal is equal to or greater than bandwidth allocated to the audio signal of the general broadcast signal, and bandwidth allocated to the video signal out of the entire bandwidth of the music broadcast signal is less than bandwidth allocated to the video signal of the general broadcast signal.

Meanwhile, the DTV is used as an example to describe the embodiment of the present invention. However, the present invention is not limited to the DTV, and any broadcast receiving apparatus, which can perform signal processing to receive and output the broadcast signal, such as a set top box, a TV with a built-in set top box, and a mobile communication device which can receive broadcast, can be applied.

As described above, according to the present invention, when audio is normally output but corresponding video is not output yet at the beginning of receiving the music broadcast, the user can recognize that the video is being delayed by information displayed to inform the user about the video receiving delay. Accordingly, user inconvenience due to omission of video at the beginning of music broadcast reception can be prevented. Further, the user can recognize that video will be output soon, and the user will not incorrectly think that the broadcast receiving apparatus is malfunctioning.

Further, according to the present invention, as the user can recognize a video receiving rate and an estimated point of time to acquire the first frame of video, he or she can expect to know when the video output starts.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method for informing a user of a video receiving delay, comprising:
separating a video signal from a received broadcast signal, decoding the video signal, and storing the video signal;
determining if a video signal corresponding to the first frame of video is completely decoded, after a certain amount of time from the beginning of receiving the broadcast signal; and
processing to display information on video receiving delay, if it is determined that the video signal corresponding to the first frame of the video is not completely decoded.

2. The method as claimed in claim 1, further comprising:
determining a rate of receiving the video signal; and
processing to display the determined receiving rate.

3. The method as claimed in claim 2, wherein the determining the rate of receiving the video signal refers to the header of the video signal.

4. The method as claimed in claim 1, further comprising:
determining a rate of receiving the video signal;
calculating an estimated point of time to completely decode the video signal corresponding to the first frame of the video based on the determined receiving rate; and
processing to display the calculated estimated point of time.

5. The method as claimed in claim 1, wherein the broadcast signal is a music broadcast signal transmitted from a music broadcasting station.

6. The method as claimed in claim 5, wherein a receiving rate of an audio signal of the music broadcast signal is equal to or greater than a receiving rate of the audio signal of a general broadcast signal, and
a receiving rate of the video signal of the music broadcast signal is less than a receiving rate of the video signal of the general broadcast signal.

7. The method as claimed in claim 5, wherein a bandwidth allocated to the audio signal out of the entire bandwidth of the music broadcast signal is equal to or greater than a bandwidth allocated to the audio signal of the general broadcast signal, and
a bandwidth allocated to the video signal out of the entire bandwidth of the music broadcast signal is less than a bandwidth allocated to the video signal included in the general broadcast signal.

8. A broadcast receiving apparatus, comprising:
a display information combining part adapted to process for display a predetermined information;
a determination part adapted to determine if the video signal corresponding to the first frame, of the video is completely decoded, after a certain amount of time from the beginning of receiving the broadcast signal; and
a controlling part adapted to control the display information combining part to display information on video receiving delay, if the determination part determines that the video signal corresponding to the first frame of the video is not completely decoded.

9. The broadcast receiving apparatus as claimed in claim 8, wherein the determination part determines the rate of receiving the video signal, and
the controlling part controls the display information combining part to display the receiving rate determined by the determination part on screen.

10. The broadcast receiving apparatus as claimed in claim 9, wherein the determination part determines the receiving rate of the video signal in the header of the video signal.

11. The broadcast receiving apparatus as claimed in claim 8, wherein the determination part determines the receiving rate of the video signal, and
the controlling part calculates an estimated point of time to completely decode the video signal corresponding to the first frame of the video based on the determined receiving rate, and controls the display information combining part to display the calculated estimated point of time.

12. The broadcast receiving apparatus as claimed in claim 8, wherein the broadcast signal is the music broadcast signal transmitted from the music broadcasting station.

13. The broadcast receiving apparatus as claimed in claim 12, wherein the receiving rate of the audio signal of the music broadcast signal is equal to or greater than the receiving rate of the audio signal of the general broadcast signal, and the receiving rate of the video signal of the music broadcast signal is less than the receiving rate of the video signal of the general broadcast signal.

14. The broadcast receiving apparatus as claimed in claim 12, wherein the bandwidth allocated to the audio signal out of the entire bandwidth of the music broadcast signal is equal to or greater than the bandwidth allocated to the audio signal of the general broadcast signal, and the bandwidth allocated to the video signal out of the entire bandwidth of the music broadcast signal is less than the bandwidth allocated to the video signal of the general broadcast signal.
